(19) United States
(12) Patent Application Publication
(10) Pub. No.: US 2005/0144639 A1
(43) Pub. Date: Jun. 30, 2005

(54) Apparatus and method for controlling program

(75) Inventor: Hyung Suk Kim, Daegu-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/023,571

(22) Filed: Dec. 29, 2004

(30) Foreign Application Priority Data
Dec. 30, 2003 (KR) 99781/2003

(51) Int. Cl. H04N 5/445; G06F 3/00; H04N 7/10; H04N 7/025; G06F 13/00

(52) U.S. Cl. 725/53; 725/52; 725/37

(57) ABSTRACT

A program control in a display device is provided. In a display device including a tuner and a demultiplexer, an apparatus for controlling a program includes: a key input unit for inputting data; a storage unit for storing program information separated by the demultiplexer; a display unit for displaying at least one of a video signal separated by the demultiplexer, a keyword inputted through the key input unit so as to search a program, and a program corresponding to the keyword; and a control unit electrically connected to the units, for searching an information corresponding to the keyword from the storage unit, the keyword being inputted through the key input unit so as to search the program information, displaying the searched information, and selecting the displayed program to thereby control a channel switching. Accordingly, the program related keyword information is inputted and a corresponding program is displayed, such that a user can select a specific program.

### BACKGROUND OF THE INVENTION

1. Field of the Invention

The present invention relates to an apparatus and method for controlling a program in a display device.

2. Description of the Related Art

As a digital broadcasting is recently accelerating, a broadcasting service of high video/audio quality is provided through a satellite/terrestrial wave/cable.

Compared with a related art analog TV, a digital broadcasting has advantages that can provide a variety of additional services as well as high video/audio quality.

Such a digital broadcasting compresses high-quality audio/video (A/V) data by using an audio/video compression method (for example, MPEG-2, AC-3, etc.) and transmits the compressed A/V data to users through a satellite/terrestrial wave/cable band by using QPSK/VSB/QAM method. Thus, a variety of services can be provided over one channel.

In the case of the terrestrial wave, four or more standard definition (SD) channels can be provided over one channel and one high definition (HD) channel can be provided.

Also, in order to provide a variety of services, a digital TV transmits a data signal together with an audio/video information. Using this information, a service such as a broadcasting guide to the increased channels can be provided.

That is, unlike the past when only a sky wave channel could be received, a variety of broadcasting channels can be received through a cable or a satellite broadcasting at the present time. Also, many methods that can effectively separate and manage about fifty to about hundred channels.

Accordingly, compared with the related art analog broadcasting, much more channels can be broadcast due to developments of the audio/video compression technology and the transmission technology. In the related art, the user spent a lot of time finding a favorite channel among the increased channels.

A TV is a system that processes the broadcasting information contained in the broadcasting program so that the users can watch it. Regardless of age or stratum, the users can come in contact with a variety of information while watching the broadcasting program.

In addition, the TV is the most popular one of the rapidly developing multimedia and is gradually changing from an analog system to a digital system.

Hereinafter, an image display device and a channel editing method thereof will be described with reference to the accompanying drawings.

FIG. 1 is a schematic block diagram showing a construction of a related art display device.

Referring to FIG. 1, the related art display device includes at least one tuner 101, a demultiplexer 102, a video signal processing unit 103, a display unit 104, a key input unit 105, a control unit 106, an audio signal processing unit 107, and a speaker 108.

The tuner 101 receives a broadcasting signal through an antenna 100 and selects a desired channel. The demultiplexer 102 separates a video signal, an audio signal and a data signal from the broadcasting signal selected by the tuner 101. The video signal processing unit 103 receives and processes the video signal separated by the demultiplexer 102, so that the video signal can be displayed on the display unit 104. The audio signal processing unit 107 receives and processes the audio signal separated by the demultiplexer 102, so that the audio signal can be outputted through the speaker 108. The key input unit 105 allows the user to input a command or a control key depending on the channel selection, and the control unit 106 controls the system.

An operation of the related art display device will be described below.

First, if the user inputs a power-on command through the key input unit 105, the broadcasting signal received through the tuner 101 is separated into the video signal, the audio signal and the data signal information by the demultiplexer 102. Then, the video signal, the audio signal and the addition information are respectively processed and outputted through the display unit 104 and the speaker 108.

However, in case where the user wants to switch the channel, if a channel switching command is inputted through the key input unit 105, the control unit 106 receives the channel switching command and generates a control signal to the tuner 101.

FIG. 2 is a flowchart showing a channel selecting method of the related art display device.

First, if the user inputs the power-on command, a picture received through the antenna 100 is displayed (S201, S202).

Then, it is checked whether the user inputs a channel switching command through the key input unit 105 (S203).

If the channel switching command is inputted, a picture of the corresponding channel depending on the channel switching key is displayed (S204).

If the user inputs a power-off command, the process stops (S205).

At this point, the channel switching command inputted through the key input unit 105 selects a desired channel, depending on the input of channel up/down commands. When the user inputs the channel up/down commands, a picture of only the corresponding channel is displayed. Therefore, if the corresponding channel is not desired, the user must input the channel up/down command again and select a desired channel after checking the changed channel. It is inconvenient to the user.

Further, since the channel is up or down one by one, it takes a lot of time to select a desired channel from a plurality of channel, such as 69 wireless channels, 125 cable channels and 69 DTV channels.

### SUMMARY OF THE INVENTION

Accordingly, the present invention is directed to an apparatus and method for controlling a program that substantially obviates one or more problems due to limitations and disadvantages of the related art.

An object of the present invention is to provide an apparatus and method for controlling a program, in which a program related keyword information is inputted and a corresponding program is displayed, such that a user can select the program.

Another object of the present invention is to provide an apparatus and method for controlling a program, in which if a broadcasting program title, a broadcasting station name, a channel or a broadcasting time is inputted in a character, a related information is displayed.

A further another aspect of the present invention is to provide an apparatus and method for controlling a program, in which a switching to a corresponding channel, a recording, a reservation viewing and a reservation recording of the corresponding channel are performed by referring to and selecting a displayed program information.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for controlling a program in a display device including a tuner and a demultiplexer. The apparatus includes: a key input unit for inputting data; a storage unit for storing program information separated by the demultiplexer; a display unit for displaying at least one of a video signal separated by the demultiplexer, a keyword inputted through the key input unit so as to search a program, and a program corresponding to the keyword; and a control unit electrically connected to the units, for searching an information corresponding to the keyword from the storage unit, the keyword being inputted through the key input unit so as to search the program information, displaying the searched information, and selecting the displayed program to thereby control a channel switching.

In another aspect of the present invention, there is provided a method for controlling a program, including the steps of: receiving an information related to a broadcasting program; inputting a program related keyword information through an input unit so as to search a broadcasting program; checking whether the inputted keyword information is matched with the received program information; and displaying the matched program information.

Accordingly, the program related keyword information is inputted and a corresponding program is displayed, such that a user can select a specific program.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic block diagram showing a construction of a related art display device;

FIG. 2 is a flowchart showing a channel selecting method of the related art display device;

FIG. 3 is a block diagram of a display device in which a channel switching is executed according to the present invention;

FIG. 4 is a block diagram illustrating a construction and operation of a digital TV according to an exemplary embodiment of the present invention;

FIG. 5 is a flowchart illustrating a channel selecting and displaying method of the display device according to the present invention;

FIG. 6 is a flowchart schematically illustrating a channel switching and display method according to the present invention; and

FIGS. 7 and 8 are diagrams illustrating examples of the channel switching and displaying method.

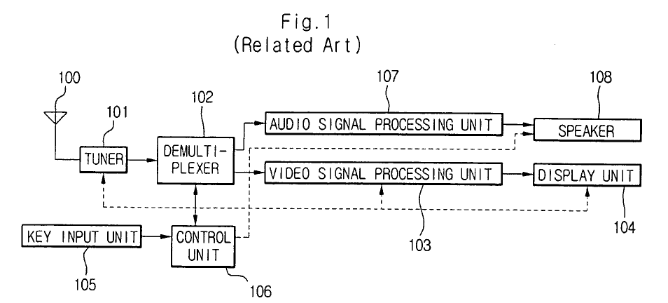

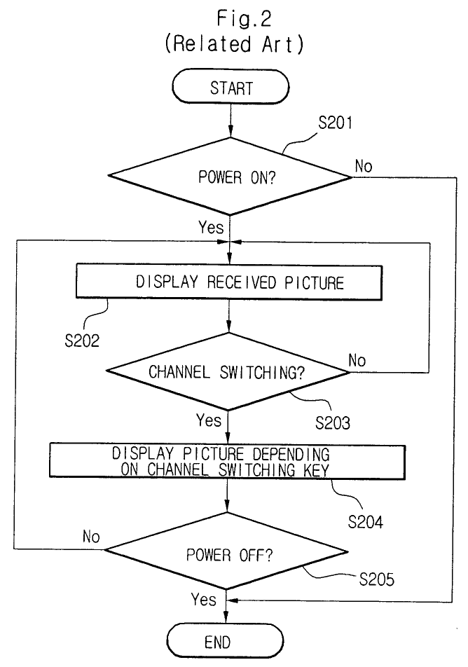

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

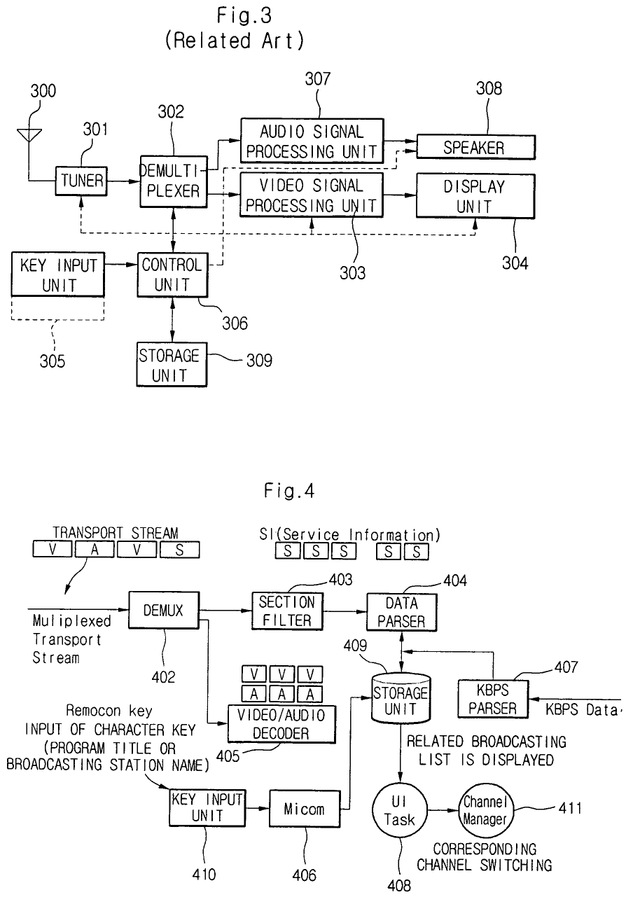

FIG. 3 is a block diagram of a display device in which a channel switching is executed according to the present invention.

Referring to FIG. 3, the display device according to the present invention includes at least one tuner 301, a demultiplexer 302, a video signal processing unit 303, a display unit 304, a key input unit 305, a control unit 306, an audio signal processing unit 307, a speaker 308, and a storage unit 309.

The tuner 301 receives a broadcasting signal through an antenna 300 and selects a desired channel. The demultiplexer 302 separates a video signal, an audio signal and a data signal from the broadcasting signal selected by the tuner 301. The video signal processing unit 303 receives and processes the video signal separated by the demultiplexer 302, so that the video signal can be displayed on the display unit 304. The audio signal processing unit 307 receives and processes the audio signal separated by the demultiplexer 302, so that the audio signal can be outputted through the speaker 308. The key input unit 305 allows the user to input a request command or a channel selection information, for example, a character or the like. The storage unit 309 stores a channel information separated by the demultiplexer 302. The display unit 304 displays the video signal separated by the demultiplexer 302, and also displays an information input window for selecting a channel according to a user request and a channel information corresponding to a character information inputted on the information input window. If the user selects a channel switching mode through the key input unit 305, the control unit 306 enables the information input window to be displayed on the display unit 304, extracts all program information, which is stored in the storage unit 309 and corresponds to the information inputted through the information input window, and displays the extracted program information, so that the user can selects the desired channel with reference to the displayed information.

The program information is stored in the storage unit 309 based on an electronic program guide (EPG) provided in the digital broadcasting.

In brief, the EPG means “TV program schedule”.

In addition to the TV program schedule, the digital broadcasting receives an information on a current time through a program and system information protocol (PSIP), which is a minimum data information.

A channel switching method of the display device according to the present invention will be described below.

If the user inputs a power-on command through the key input unit 305, video and audio signals of an already selected channel are received and displayed on the display unit 304.

When the user wants to switch the channel, the information input window for selecting a desired channel is displayed on the display unit 304 by pressing a hot key additionally provided on the key input unit 305 or by selecting the channel switching button on a menu of the display device, thereby eliminating an inconvenience caused by a successive use of the channel switching key.

Then, if the user inputs a program related keyword on the information input window displayed on the display device 304, the control unit 306 searches a character string matching with the inputted keyword and displays a program information corresponding to the character string on the display unit 304.

At this point, the information inputted by the user can be a character or a number and includes at least one of a desired broadcasting program title, a broadcasting station name, a broadcasting channel and an on-air time.

The information input window and the corresponding program information are displayed on a sub screen of the display unit 304.

If the user selects the desired program from the program related list displayed on the display unit 304, the control unit 306 checks whether the selected program is now on air or not and controls the channel switching or recording. If necessary, the control unit 304 controls a reservation recording or a reservation viewing.

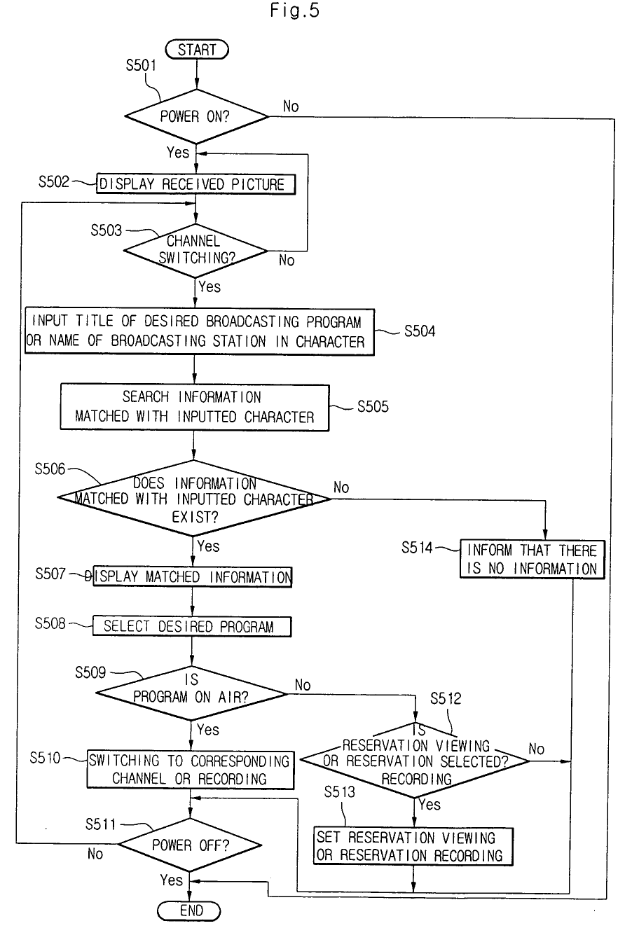

FIG. 4 is a block diagram illustrating a construction and operation of a digital TV according to an exemplary embodiment of the present invention.

As described above, in searching the desired broadcasting program, the user must know a broadcasting information about a current on-air program or a program to be broadcast.

Generally, in the digital broadcasting, the broadcasting program is loaded on a program and system information protocol (PSIP), an event information table (EIT) or an event text table (ETT).

Meanwhile, in the analog broadcasting, the broadcasting program is loaded on a KBPS data of a vertical blanking interval (VBI).

Accordingly, by using the PSIP and KBPS information, it is possible to switch to the channel corresponding to the program related keyword inputted by the user.

In the digital broadcasting, the video signal, the audio signal and the data are transmitted in a digital signal format.

The digital signal of the digital broadcasting is inputted to the demultiplexer 402 in a transport stream (TS) format.

The TS consists of 188-byte packets and one packet is called a transport packet (TP).

The TP consists of a video packetized elementary stream (PES), an audio PES and data.

A TP decoder (not shown) of the demultiplexer separates the TP into video (V), audio (A) and data (for example, service information) and transmits them to a video/audio decoder 405 and a section filter 403. The data becomes the PSIP information.

The video/audio decoder 405 decodes the video and audio PESs into video and audio signals in time.

In addition, the section filter 403 separates the PSIP information into respective tables. In order to obtain data or program information required in switching the channel, the separated tables are transmitted to a data parser 404.

The data parser 404 obtains a broadcasting station name, a program title, a channel number, a time or a rating information from the tables.

The information obtained by the data parser is stored in a database 409 and the system can access and use the stored information at any time.

Accordingly, the broadcasting program that the user selects through the key input unit 410 is searched in the storage unit under a control of a microcomputer 406 and the corresponding channel information is transmitted to a user interface (UI) task 408.

The UI task 408 transmits the corresponding channel information to a channel manager 411, thereby switching to the corresponding channel.

Meanwhile, the KBPS parser 407 parses the KBPS data loaded on the VBI of the analog broadcasting and stores it in the database 409.

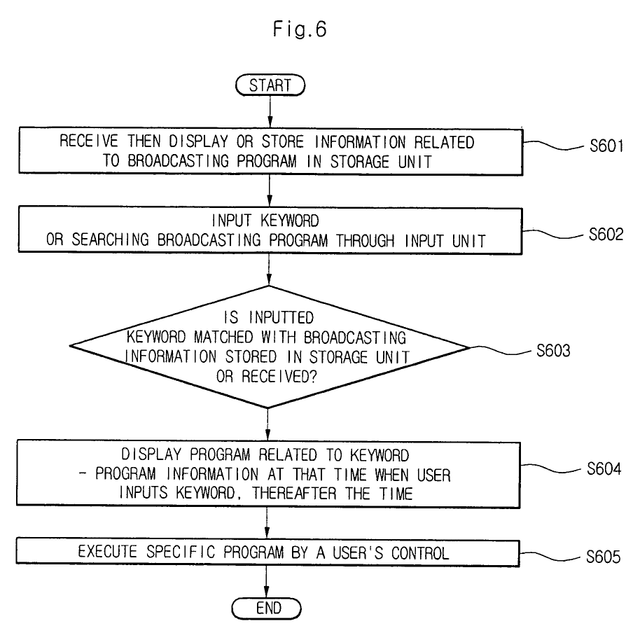

FIG. 5 is a flowchart illustrating a channel selecting and displaying method of the display device according to the present invention.

First, it is checked whether the power-on command is inputted or not (S501).

If the power-on command is inputted, the incoming broadcasting signal (for example, the video signal, the audio signal and the data) is outputted (S502).

If the user selects the channel switching mode through the key input unit 305, the information input window is displayed on the display unit 304 and the user inputs the keyword related to the desired broadcasting program, for example, the broadcasting program title or the broadcasting station name (S503, S504).

Then, it is searched whether there exists an information matching with the inputted information or not (S505).

If the information matching with the inputted information exists, the corresponding program information list is displayed (S506, S507).

The desired program is selected from the displayed program information list (S508).

Then, it is checked whether the selected program is now on air or not (S509).

If the selected program is on air, the switch to the corresponding channel or the recording of the selected program is performed (S510).

If the user inputs the power-off command, the process ends (S511).

Meanwhile, in step S509, if the program selected by the user is not on air, it is determined whether to select the reservation viewing/recording recording (S512).

If the user wants to the reservation viewing/reservation recording, the reservation viewing/reservation recording of the corresponding program is set (S513).

In addition, in step S506, if no information matching with the inputted information exists in the storage unit, it is preferable to inform that there is no information (S514).

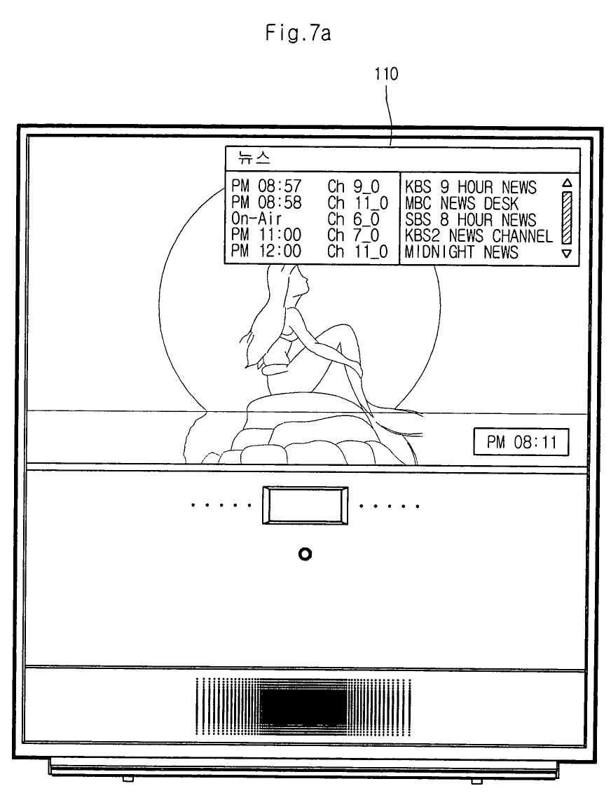

FIG. 6 is a flowchart schematically illustrating a channel switching and display method according to the present invention.

As shown in FIGS. 3 and 4, the information related to the broadcasting program is inputted to the tuner and the demultiplexer and is stored in the storage unit (S601).

The incoming information related to the broadcasting program is directly analyzed in real time after the channel selection, or it is temporarily stored in a memory and then used to select the desired channel.

The program related keyword for searching the broadcasting program is inputted through the key input unit (S602).

It is checked whether the inputted keyword information is matched with the stored program information or not (S603).

The matched program information is displayed (S604).

When displaying the matched program information, it is preferable to display the information that will be broadcast at or after time inputted by the user.

The displayed program information is automatically or manually selected to perform the viewing, recording or reservation (reservation viewing/reservation recording) operation (S605).

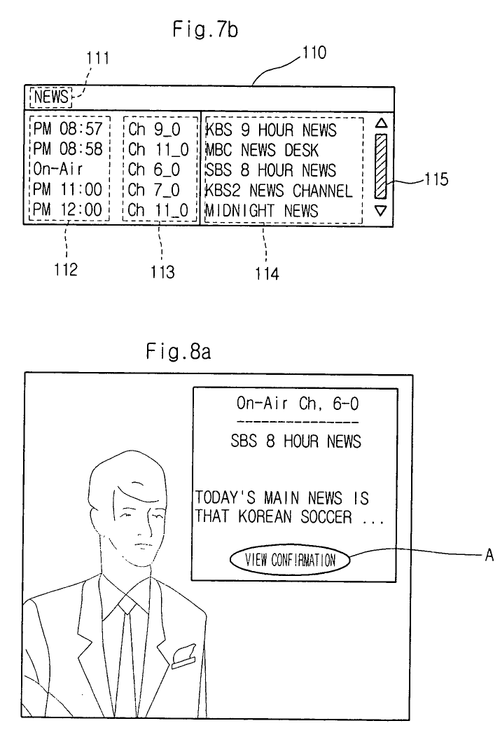

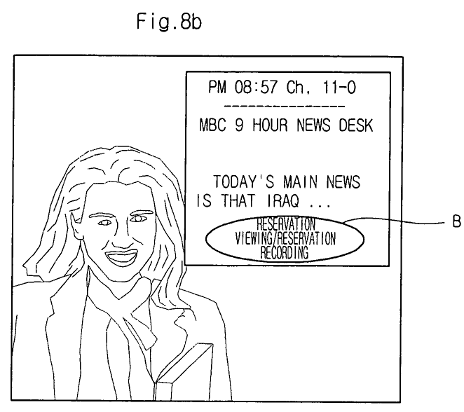

The channel switching and displaying method will be described with reference to FIGS. 7 and 8.

First, if the user inputs the hot key or selects the channel switching mode on the menu, an information input window 110 is displayed as shown in FIGS. 7A and 7B. If the user inputs the desired broadcasting program title or broadcasting station name, the broadcasting information related to the inputted character is displayed.

At this point, the displayed broadcasting information includes a broadcasting time 112, a broadcasting channel 113, a broadcasting program title 114, a broadcasting station name or the like. Also, a selection bar 115 for selecting them is displayed simultaneously.

In the list where the broadcasting time 112 is displayed, if the corresponding program is on air, “On-Air” is displayed. On the contrary, if the corresponding program is not on air, a corresponding broadcasting time is displayed.

That is, in case where “On-Air” is displayed, the channel can be switched immediately. On the contrary, if the corresponding program is not on air, the reservation viewing or the reservation recording can be set.

As a first example of inputting the program related keyword, if the user inputs a keyword “news”, all programs having the character string “news” are searched from the storage unit. “KBS Nine hour news”, “MBC news desk”, “SBS Eight hour news”, “KBS 2 news channel”, “midnight news” or the like are searched and displayed, and the broadcasting channels and time zones of the respective news programs are displayed.

In this case, if the user further inputs a keyword “de”, all lists except “MBC news desk” disappear. That is, if the representative character that can differentiate the desired program from other programs is inputted again, all programs except the corresponding program are removed.

As a second example of inputting the program related keyword, the user inputs the program information in more detail than the first input information.

For example, if the program which the user wants to watch or make the reservation viewing/reservation recording is broadcast at 9 hour, a detailed information can be inputted like “9 hour news”.

As a third embodiment of inputting the program related keyword, a minimum program information is inputted.

For example, when the user wants to know the information about the news programs, the related programs are displayed by inputting “ns”, which is a minimum information of “news”, and as an another example the user can input an acrophony word, such as “GH” in the General Hospital.

Accordingly, if the program marked with “On-Air” in the broadcasting time is selected among the displayed news programs in FIG. 7B, the program information about the corresponding program can be confirmed on the sub screen of the current incoming picture, as shown in FIG. 8A. If the user inputs a View Confirmation key A, the channel is immediately switched to the corresponding channel.

Meanwhile, if other program instead of the on-air program is selected among the displayed news programs, a synopsis and a broadcasting time of the selected program are displayed on the sub screen and the user can select the reservation viewing or the reservation recording by inputting the reservation viewing/reservation recording key B, as shown in FIG. 8B.

That is, in case where the program is selected by the user's setup, if the program is on air, the automatic channel switching is performed. On the contrary, if the program is not on air, the reservation viewing and reservation recording are performed.

As described above, in the apparatus and method for controlling the program according to the present invention, the keyword related to the broadcasting program is inputted on the information input window through the key input unit in the multiple channel system, and the broadcasting program information matched with the inputted keyword is displayed, such that the user can easily access the desired channel.

According to the present invention, the program corresponding to the information about the program related keyword is displayed so that the specific program can be selected.

Even when the user does not know the program channel number, if the program title or the broadcasting station name is inputted in a character, the corresponding program information is displayed, thereby reducing the inconvenience in finding the channels one by one through the related art channel switching key.

Since the user can select and watch the desired program, the desired program can be selected more conveniently.

The user can set the reservation recording or reservation viewing as well as the channel switching by checking whether the selected program is on air or not, thereby improving the user satisfaction.

It will be apparent to those skilled in the art that various modifications and variations can be made in the present invention. Thus, it is intended that the present invention covers the modifications and variations of this invention provided they come within the scope of the appended claims and their equivalents.

1. An apparatus for controlling a program in a display device including a tuner and a demultiplexer, the apparatus comprising:
a key input unit for inputting data;
a storage unit for storing program information separated by the demultiplexer;
a display unit for displaying at least one of a video signal separated by the demultiplexer, a keyword inputted through the key input unit so as to search a program, and a program corresponding to the keyword; and
a control unit electrically connected to the units, for searching an information corresponding to the keyword from the storage unit, the keyword being inputted through the key input unit so as to search the program information, displaying the searched information, and selecting the displayed program to thereby control a channel switching.

2. The apparatus according to claim 1, wherein the key input unit includes elements for inputting a user control command, a channel switching mode and a program related keyword.

3. The apparatus according to claim 1, wherein the display unit displays the video signal separated by the demultiplexer, an information input window for selecting a channel depending on a user's control, and a program information corresponding to an information inputted on the information input window.

4. The apparatus according to claim 1, wherein if the user selects a channel switching mode through the key input unit, the control unit enables an information input window to be displayed on the display unit so as to select a channel, extracts a program information, which is stored in the storage unit and corresponds to the information inputted through the information input window, and displays the extracted program information, thereby allowing a channel switching to a program that is selected from the displayed program information.

5. The apparatus according to claim 1, wherein the program information includes at least one of a broadcasting station name, a program title, a channel and a broadcasting time.

6. The apparatus according to claim 3, wherein the video signal separated by the demultiplexer is displayed on a main screen of the display unit, and the information input window and the program information are displayed on a sub screen.

7. The apparatus according to claim 4, wherein the control unit checks whether the channel selected by the user is on air or not, and performs at least one of a reservation viewing, a reservation recording, a viewing and a recording.

8. A method for controlling a program in a channel selection of a display device including a key input unit, a tuner, a storage unit and a display unit, the method comprising the steps of:
if a power-on command is inputted, displaying a broadcasting signal inputted through the tuner;
if a user selects a channel switching mode, displaying an information input window for enabling a channel selection;
inputting a program related keyword information in the displayed information input window;
extracting a program information corresponding to the program related keyword information from the storage unit, and displaying the extracted program information;
selecting the displayed program information; and
performing an operation corresponding to the selected result.

9. The method according to claim 8, wherein the program related keyword information inputted in the information input window includes at least one of a broadcasting station name, a program title, a channel and a broadcasting time.

10. The method according to claim 8, further comprising the step of:
checking whether the program information corresponding to the information inputted by the user exists in the storage unit; and
extracting the program information related to the inputted information from the storage unit and displaying the extracted program information.

11. The method according to claim 8, further comprising the step of:
if the selected program is on air, displaying a synopsis of the corresponding program on a sub screen; and
if the user inputs a viewing confirmation command, switching to the corresponding channel.

12. The method according to claim 8, wherein if the selected program is on air, performing at least one of a channel switching, a viewing and a recording depending on a user's selection.

13. The method according to claim 8, wherein if the selected program is not on air, performing a reservation viewing and a reservation recording depending on a user's selection.

14. The method according to claim 8, wherein the program information displayed corresponding to the program related keyword information inputted by the user displays the information that is to be broadcast at or after time inputted by the user.

15. A method for controlling a program, comprising the steps of:
receiving an information related to a broadcasting program;
inputting a program related keyword information through an input unit so as to search a broadcasting program;
checking whether the inputted keyword information is matched with the received program information; and
displaying the matched program information.

16. The method according to claim 15, further comprising the step of selecting and operating the displayed program information.

17. The method according to claim 15, wherein the received information related to the broadcasting program is directly analyzed after a channel selection.

18. The method according to claim 15, wherein the received information related to the broadcasting program is stored in a memory and used to select a channel desired by a user.

19. The method according to claim 15, wherein the display number of the matched information is varied depending on a data information inputted by a user.

20. The method according to claim 15, wherein the inputted keyword information is more than a minimum information representing a program.

21. The method according to claim 20, wherein the information representing the program includes at least one an acrophony information and a program related information.
